(19) United States
(12) Patent Application Publication
(10) Pub. No.: US 2022/0039495 A1
(43) Pub. Date: Feb. 10, 2022

(54) Mask Holder And Methods Of Use Thereof

(71) Applicant: MATCHLESS PLASTICS, INC., Plymouth, MN (US)

(72) Inventor: Jeffrey P. Mark, Plymouth, MN (US)

(21) Appl. No.: 17/398,096

(22) Filed: Aug. 10, 2021

Related U.S. Application Data
(60) Provisional application No. 63/063,624, filed on Aug. 10, 2020.

(51) Int. Cl. A41D 13/11

(52) U.S. Cl. CPC A41D 13/1161

(57) ABSTRACT

An apparatus for holding a mask for covering a mouth and a nose of a user is disclosed. The mask can comprise at least one strap. The apparatus can comprise a handle having a first end and a second end spaced relative to a central axis. First and second arms can be coupled to the second end of the handle. The first and second arms can extend from the handle in a direction from the first end of the handle to the second end of the handle and are spaced from each other relative to a first transverse axis. Each of the first and second arms can comprise at least one strap retainer that is configured to receive the at least one strap so that the at least one strap is inhibited from sliding relative to the at least one strap retainer.

### CROSS-REFERENCE TO RELATED APPLICATION

This application claims priority to and the benefit of the filing date of U.S. Provisional Patent Application No. 63/063,624, filed Aug. 10, 2020, which is incorporated herein by reference in its entirety.

### FIELD

This application relates apparatuses, assemblies, and methods for covering at least the nose and mouth of an individual.

### BACKGROUND

Masks (e.g., surgical masks) are conventionally worn over the mouth and nose of a user to inhibit transfer of particles and contaminants to or from the user. A conventional mask can comprise a sheet of material (e.g., cloth or polymer spunbond material) and first and second elastic straps on opposing sides of the sheet of material for looping around respective ears of the user. However, it is not always desirable to wear the mask, but repetitive removal and re-donning is time consuming and unpleasant for the wearer. For example, when receiving a haircut, the straps have to be repeatedly move/removed in order to cut around the ears and neck of the user. As another example, when eating at a restaurant individuals have to remove their masks to permit eating for every bite. Accordingly, a way to provide intermittent access to a mask is desirable.

### SUMMARY

Disclosed herein, in one aspect, is an apparatus for holding a mask for covering a mouth and a nose of a user, the mask comprising at least one strap. The apparatus can comprise a handle having a first end and a second end spaced relative to a central axis. First and second arms can be coupled to the second end of the handle. The first and second arms can extend from the handle in a direction from the first end of the handle to the second end of the handle and are spaced from each other relative to a first transverse axis. Each of the first and second arms can comprise at least one strap retainer that is configured to receive the at least one strap so that the at least one strap is inhibited from sliding relative to the at least one strap retainer.

An assembly can comprise a mask and the apparatus for holding the mask, wherein the at least one strap is retained by the at least one retainer of each of the first and second projections.

A method can comprise engaging the at least one strap of the mask with the at least one retainer of each of the first and second projections.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a front view of a mask holder in accordance with embodiments disclosed herein.

FIG. 2 is a side view of the mask holder of FIG. 1.

FIG. 3 is a front view of another mask holder in accordance with embodiments disclosed herein with a mask attached thereto.

FIG. 4 is a front view of the mask older of FIG. 3 without the mask.

FIG. 5 is an exploded partial perspective view of the mask holder of FIG. 3, showing a bottom end of the handle of the mask holder and a plug for receipt within the handle.

FIG. 6 is a cross sectional view of the mask holder of FIG. 3 with the plug received within the handle.

FIG. 7 is a bottom view of the mask holder of FIG. 3.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” include plural references unless the context clearly dictates otherwise. Thus, for example, reference to “a notch” includes one or more of such notches, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification. Thus, words denoting order, such as “first” or “next,” should be interpreted as optional aspects unless plain meaning or logic dictates otherwise.

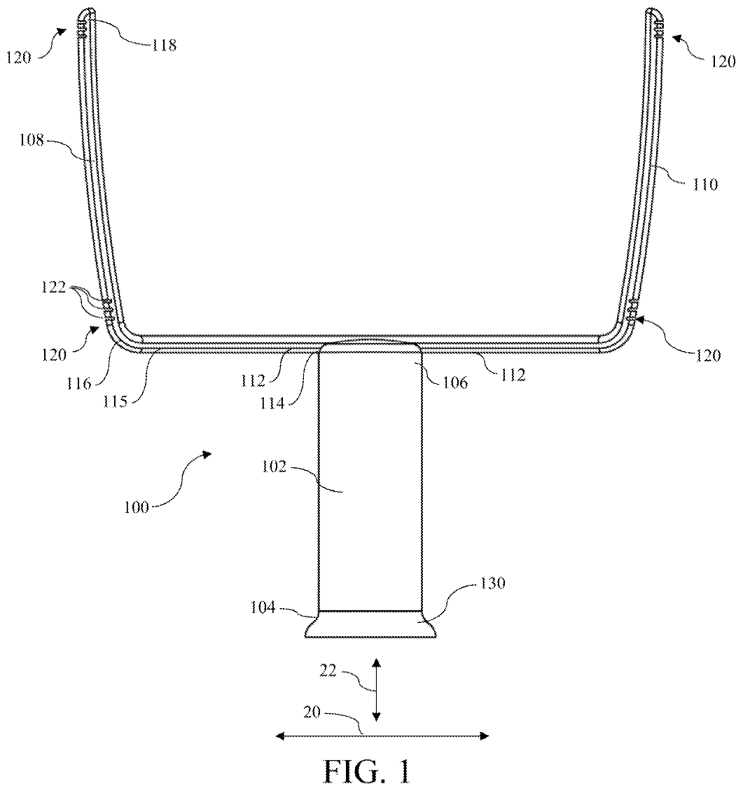

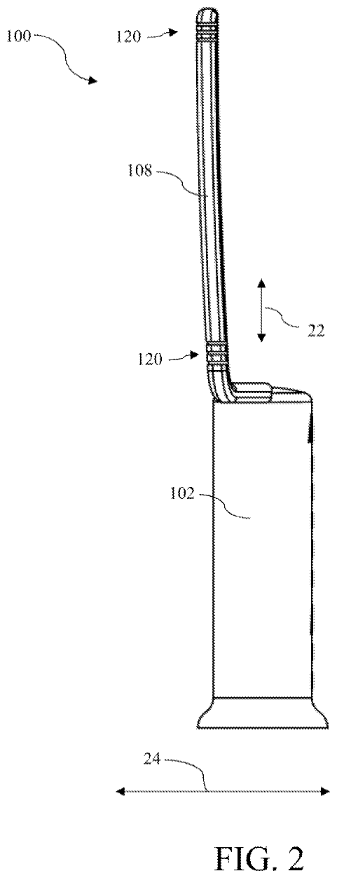

Disclosed herein, in various aspects and with reference to FIGS. 1-2, is a mask holder 100 for holding a mask 10. The mask 10 can comprise a covering material 12 that is configured to cover a mouth and nose of a user/wearer and at least one strap 14. For example, the mask 10 can comprise a pair of elastic straps 14 that are coupled to opposing sides of the mask that are spaced relative to a first transverse axis 20. The straps can be configured to extend around the ears of a user.

The mask holder 100 can comprise a handle 102 having a first end 104 and a second end 106 spaced relative to a central axis 22. Optionally, the handle 102 can define a radially extending flange 130 at its first end 104. The flange 130 can enable the mask holder 100 to be balanced upright on its first end 104. The mask holder can further comprise a first arm 108 and a second arm 110 that couple to and extend from the second end 106 of the handle 102 relative to the central axis 22. That is, the first and second arms 108, 110 can extend from the second end of the handle 102 in a general direction from the first end 104 to the second end 106 of the handle 102. For example, in some optional aspects, the first and second arms can be generally parallel and can extend generally parallel to the central axis 22. As used herein, in various optional aspects, the term “generally parallel” can include orientations that are within 15 degrees, within 10 degrees, within 5 degrees, or within 1 degree of parallel. In further optional aspects, the first and second arms can extend in respective directions so that they diverge from each other in a distal direction away from the handle (i.e., in the direction from the first end to the second end of the handle). Optionally, the first and second arms can define an arcuate profile. The arcuate profile can enable the mask holder 100 to conform to a variety of different facial proportions, thereby assuring proper fitting of the mask to the user's nose and mouth. In some optional aspects, the handle can have a diameter of about 1.5 inches and a length from about 4 inches to about 4.5 inches. In some optional aspects, the first and second arms 108, 110 can each have a diameter of about 0.10 inches to about 0.40 inches (optionally, about 0.25 inches) and a length of about 4 inches to about 6 inches (optionally, about 5 inches). Optionally, the first and second arms 108, 110 can be spaced by about 7 to about 8 inches relative to the first transverse axis 20. Optionally, the arms can comprise a flexible, resilient material so that tension provided by the straps of the mask can draw the distal ends of the arms toward each other. The flexibility of the arms can further provide a more gentle fit against the user's face. Optionally, it is contemplated that the first and second arms can taper toward their respective distal ends.

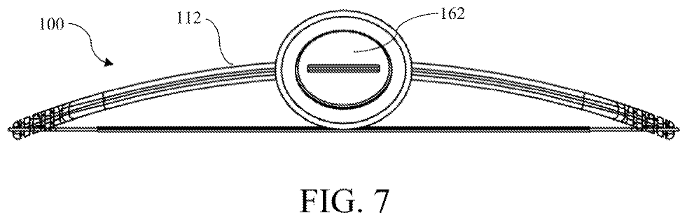

The first arm 108 and the second arm 110 can couple to the handle 102 via respective transversely extending arms 112. The transversely extending arms can have a proximal end 114 that couples to the handle 102 at the second end 106. Each of the first and second arms 108, 110 can extend from a distal end 115 of a respective transversely extending arm 112. Referring also to FIG. 7, optionally, the transversely extending arms 112 can extend from the handle 102 relative to a second transverse axis 24 that is perpendicular to the first transverse axis 20 (optionally, along an arcuate path) so that the first and second arms 108, 110 are offset from the central axis 22 relative to the second transverse axis 24. For example, optionally, the first and second arms 108, 110 can be offset from the central axis 22 relative to the second transverse axis 24 farther (e.g., by a greater distance) than the outer circumference of the handle. In this way, the mask holder 100 can extend away from the user's face when the mask engages the user's nose and mouth, thereby accommodating a wide variety of facial shapes and features (e.g., avoiding the chin of the user). Although described as having multiple transversely extending arms 112, it is contemplated that a single transversely extending arm 112 can extend continuously between the first and second arms 108, 110, with an intermediate portion of the transversely extending arm 112 being connected to the handle 102.

Optionally, each of the first and second arms 108, 110 is unitarily formed (e.g., as a monolithic structure) with the respective transversely extending arm. Optionally, the transversely extending arms can be unitarily formed (e.g., as a monolithic structure). Still further, optionally, the entire mask holder 100 can be unitarily formed (e.g., as a monolithic structure). For example, in some aspects, the mask holder 100 can be formed via injection molding. Accordingly, in some optional aspects, the mask holder can comprise polymer (e.g., FDA grade resin) and can optionally be provided in various different colors. Optionally, the mask holder can comprise a material that can be repeatedly sterilized.

Each of the first and second arms 108, 110 can comprise at least one strap retainer 120. In some aspects, the first and second arms 108, 110 can each comprise two strap retainers that can be spaced along the length of the arms (e.g., one at a proximal end 116 and one at a distal end 118 of each of the first and second arms 108, 110). Although the strap retainers are shown in the Figures in certain locations along the length of the respective arms, it is contemplated that each of the strap retainers 120 can be positioned more proximally or distally along the arms than depicted in the Figures (e.g., up or down by % z inch). In some optional aspects, each strap retainer 120 can comprise at least one notch 122. In further aspects, the strap retainer 120 can comprise two, three, or more notches 122. Optionally, in some aspects, the notches 122 can be wedge-shaped. In further optional aspects, the notches 122 can have generally consistent widths relative to the central axis 22 of the handle 102. The width of the notches 122 can be selected to be narrower than the uncompressed diameter of the strap (e.g., that of a conventional surgical mask). For example, the width of each notch 122 relative to the central axis 22 can range from about 0.03 inches to about 0.05 inches (optionally, be about 0.04 inches). In this way, the strap(s) of the mask can be compressed (pinched) therein so that the strap is inhibited from sliding and is thus held in place on the mask holder 100. Optionally, the notches 122 can be positioned on the outside surfaces of the first and second arms 108, 110 (on the opposite side of the respective arm that opposes the other arm of the first and second arm). Optionally, the notches 122 can extend about halfway through the thickness/diameter of the respective arm.

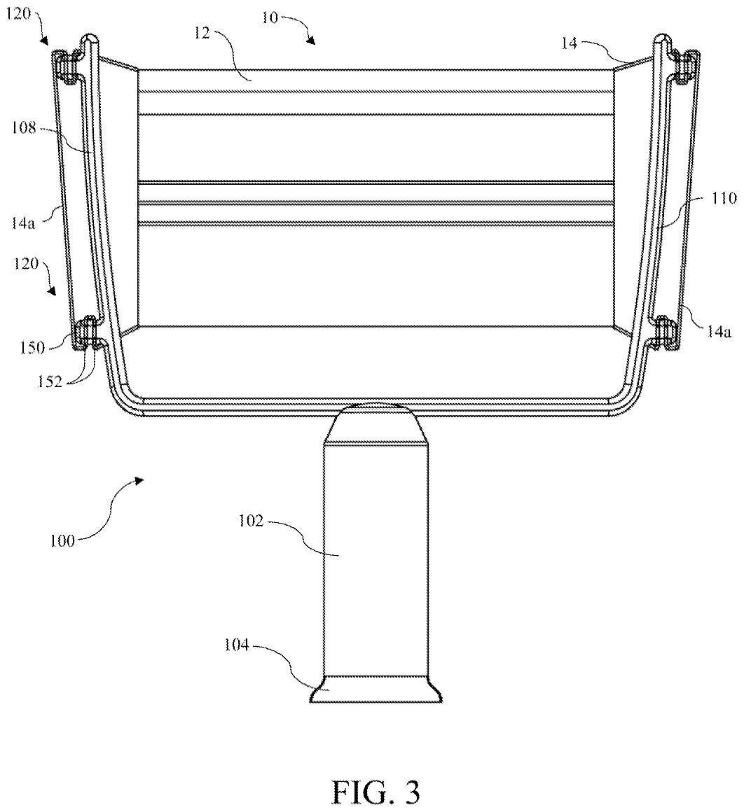

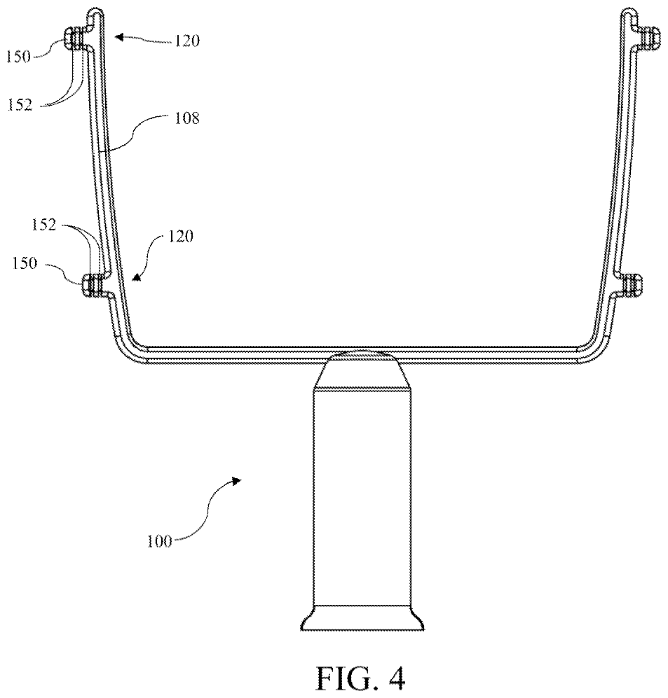

Referring to FIGS. 3-4, in further aspects, the strap retainers 120 can comprise projections 150 (e.g., attachment cleats) that extend away from (optionally, perpendicularly or generally perpendicularly (e.g., within 15 degrees, within 10 degrees, within 5 degrees, or within 1 degree of perpendicular) relative to) the direction of elongation of the arms. For example, the projections 150 can extend relative to the first transverse axis 20 and away from the opposing arm (i.e., the first arm 108 or the second arm 110). The projections 150 can define one or more (e.g., optionally, two) notches 152 that can be configured to receive a portion of a strap of the mask. Optionally, the notches 152 can extend inwardly around the entire circumference of the respective projection. In further aspects, the notches 152 can extend inwardly around a portion (e.g., the top, bottom, and front side) of the respective projection (around less than the entire circumference). The notches 152 can have a select width (e.g., optionally, 0.04 inches) that is sized to pinch the strap received therein so that the strap is inhibited from sliding within the notch. Further, the strap can be wrapped around the projection to further frictionally engage the strap retainers 120. Optionally, for each projection 150, the strap can be wedged into a first notch 152, wrapped around the projection, and then wedged into a second notch 152.

Referring to FIGS. 1-3, in some aspects, the straps 14 of the mask 10 can be engaged with the retainer(s) 120 of the first and second arms 108, 110 to form an assembly 200. For example, for a mask 10 having a first strap 14a on a first side and a second strap 14b on a second side, the first strap 14a can be wedged into one or more notches 122 of the strap retainer 120 at the proximal end of the first arm 108 and into one or more notches 122 of the strap retainer 120 at the distal end of the first arm 108. Optionally, the first strap 14a can be wrapped around the arm so that the first strap 14a can be wedged in a plurality of notches 122 of one or both of the strap retainer 120 at the proximal end of the first arm 108 and the strap retainer 120 at the distal end of the first arm 108. The second strap 14b can be wedged into one or more notches of the strap retainer 120 at the proximal end of the second arm 110 and into one or more notches 122 of the strap retainer 120 at the distal end of the second arm 110. Optionally, the second strap 14b can be wrapped around the second arm 110 so that the second strap 14b can be wedged in a plurality of notches 122 of one or both of the strap retainer 120 at the proximal end of the second arm 110 and the strap retainer 120 at the distal end of the second arm 110. Optionally, the first and second straps 14a,b can be wedged into the notches at select locations along their respective lengths so that the covering material 12 is held in tension.

The mask holder 100 and assembly 200 can be useful for providing protection when repeatedly taking off and putting on a mask in burdensome. For example, the mask holder and assembly can be used during haircuts to prevent interference with the hairdresser's tasks (e.g., washing hair, trimming around the ears, etc.). That is, the mask holder can eliminate the need for straps that extend around the user's ears or neck. Further, the mask holder and assembly can be useful during dining, public speaking, and other tasks where it is necessary to sequentially position a mask over the face and then remove the mask from the face. The mask holder can allow for quick/easy removal of the mask from the face area (e.g., to permit eating) as well as quick/easy return of the mask to the face area (after a bite is completed, etc.). The mask holder and assembly can further enable the user not to touch her head or face as is required for removal and replacement of ear straps for conventional masks.

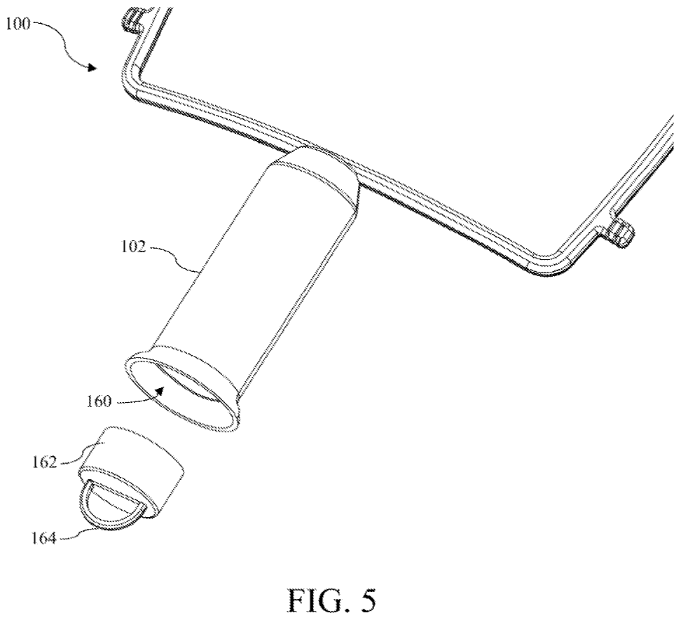

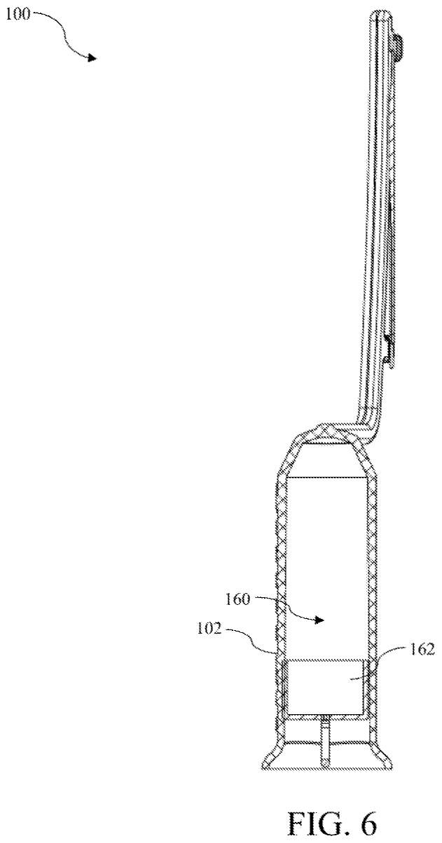

In some aspects, the handle 102 can be solid. Referring also to FIGS. 5-7, in further aspects, the handle 102 can be hollow. For example, the handle 102 can define a recess 160 that extends from the first end 104. In some aspects, the recess can be configured to receive a plug 162 so that the plug is frictionally retained within the recess. The plug can couple to a lanyard (not shown) so that the lanyard extends from the first end 104 of the handle 102. For example, the plug can define a hook 164 about which the lanyard can be tied. The lanyard can be configured to extend around the wrist or neck of the user. The plug can optionally be removed so that the mask holder 100 can be balanced upright on its end without the lanyard interfering with the balancing.

Although several embodiments of the invention have been disclosed in the foregoing specification and the following appendices, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. An apparatus for holding a facemask for covering a mouth and a nose of a user, the facemask comprising at least one strap, the apparatus comprising:
a handle having a first end and a second end spaced relative to a central axis; and
first and second arms that are coupled to the second end of the handle, wherein the first and second arms extend from the handle in a direction from the first end of the handle to the second end of the handle, and wherein the first and second arms are spaced from each other relative to a first transverse axis,
wherein each of the first and second arms comprises at least one strap retainer that is configured to receive the at least one strap so that the at least one strap is inhibited from sliding relative to the at least one strap retainer.

2. The apparatus of claim 1, wherein the first and second arms couple to the handle via respective transversely extending arms, each transversely extending arm having a proximal end and a distal end, wherein the proximal end of each transversely extending arm couples to the second end of the handle, and wherein each of the first and second arms extends from the distal end of a respective transversely extending arm.

3. The apparatus of claim 2, wherein each of the first arm and second arm is unitarily formed with the respective transversely extending arm.

4. The apparatus of claim 2, wherein the transversely extending arms are unitarily formed.

5. The apparatus of claim 1, wherein the apparatus is a monolithic structure.

6. The apparatus of claim 1, wherein the first and second arms are generally parallel.

7. The apparatus of claim 1, wherein the first and second arms diverge from each other in a distal direction from the handle.

8. The apparatus of claim 1, wherein each of the first and second arms comprise a first strap retainer and a second strap retainer.

9. The apparatus of claim 1, wherein each strap retainer comprises at least one notch.

10. The apparatus of claim 9, wherein the at least one notch is wedge-shaped.

11. The apparatus of claim 9, wherein the at least one strap has an uncompressed diameter, wherein the at least one notch has a width relative to the central axis that is narrower than the uncompressed diameter of the at least strap.

12. The apparatus of claim 11, wherein the width of the at least one notch is about 0.04 inches.

13. The apparatus of claim 9, wherein the at least one notch comprises at least two notches.

14. The apparatus of claim 13, wherein the at least one notch comprises three notches.

15. The apparatus of claim 1, wherein the at least one strap retainer comprises a projection that extends generally perpendicularly to the direction of extension of the respective arm.

16. The apparatus of claim 1, wherein the handle defines a flange at the first end.

17. The apparatus of claim 1, wherein the first and second arms are offset from the central axis of the handle relative to a second transverse axis that is perpendicular to the first transverse axis.

18. A method comprising:
coupling a facemask to an apparatus for holding the facemask, wherein the facemask comprises at least one strap, wherein the apparatus comprises:
a handle having a first end and a second end spaced relative to a central axis; and
first and second arms that are coupled to the second end of the handle, wherein the first and second arms extend from the handle in a direction from the first end of the handle to the second end of the handle, and wherein the first and second arms are spaced from each other relative to a first transverse axis,
wherein each of the first and second arms comprises at least one strap retainer,
wherein the at least one strap retainer of the first and second arms receives the at least one strap of the facemask so that the at least one strap is inhibited from sliding relative to the at least one strap retainer.

19. The method of claim 18, wherein the mask comprises a first strap and a second strap that are spaced relative to the first transverse axis, wherein each of the first and second arms comprise a first strap retainer and a second strap retainer, wherein each of the first strap retainer and the second strap retainer comprises at least one notch, the method comprising
wedging the first strap within the at least one notch of the first strap retainer of the first arm and the at least one notch of the second strap retainer of the first arm; and
wedging the second strap within the at least one notch of the first strap retainer of the first arm and the at least one notch of the second strap retainer of the second arm.

20. The method of claim 19, wherein each of the first strap retainer and the second strap retainer of each of the first and second arm comprises a projection that extends generally perpendicularly to the direction of extension of the respective arm, the method further comprising:
wrapping the first strap around the projection of the first strap retainer of the first arm.
